(19) United States
(12) Patent Application Publication
(10) Pub. No.: US 2017/0238126 A1
(43) Pub. Date: Aug. 17, 2017

(54) SENSOR FOR ACQUIRING SENSING DATA IN DISCONNECTED STATE, INTELLIGENT DEVICE, AND METHOD

(71) Applicants: Wuyang ZHAO, Beijing (CN); Dongwei ZHAO, Beijing (CN); BEIJING SENSORO CO., LTD., Beijing (CN)

(72) Inventors: Dongwei ZHAO, Beijing (CN); Weizhi ZHOU, Beijing (CN); Yachen LIU, Beijing (CN); Yao YU, Beijing (CN); Zihua LI, Beijing (CN); Baoming BAI, Beijing (CN); Xin FAN, Beijing (CN); Fengrui LIU, Beijing (CN); Xiaofei YUAN, Beijing (CN)

(21) Appl. No.: 15/328,844

(22) PCT Filed: Sep. 24, 2014
(86) PCT No.: PCT/CN2014/087253

§ 371 Date: Jan. 24, 2017

(30) Foreign Application Priority Data
Jul. 31, 2014 (CN) 201410374474.2

(51) Int. Cl. H04W 4/00; G08C 17/02

(52) U.S. Cl. CPC H04W 4/008; G08C 17/02

(57) ABSTRACT

A sensor (1) for acquiring sensing data in a disconnected state, an intelligent device (2), and a method. The sensor (1) comprises: a sensing module (11), used for detecting sensing data; a sensing data encapsulation module (12), used for encapsulating the sensing data into a valid payload data segment of a connectable non-directional Bluetooth broadcast data packet or a non-connectable non-directional Bluetooth broadcast data packet that conforms to the Bluetooth 4.0 protocol; and a Bluetooth sending module (13), used for broadcasting the connectable non-directional Bluetooth broadcast data packet or the non-connectable non-directional Bluetooth broadcast data packet. The scheme effectively solves the technical problems of low transmission efficiency and poor user experience due to one-by-one connection and data transmission in the prior art.

### FIELD OF THE INVENTION

The present invention generally relates to communication technology, and more specifically, to a sensor for acquiring sensing data in a disconnected state, an intelligent device, and a method.

### BACKGROUND OF THE INVENTION

Currently, with rapid development of low power sensor technology and mobile Internet, intelligent peripherals, wearable devices (like smart watches, bands, rings, and the like) are emerging in an endless stream, which has become a trend. When using these devices, users need to synchronize data with intelligent devices, such as smart phones, and the like, but may have a bad experience, which has yet to be solved, in transmitting data between intelligent peripherals and smart phones or other intelligent devices.

Bluetooth 4.0, which is a rapidly developing radio technology that supports short range (generally within 100 m) communication between devices, enables wireless information exchange among numerous devices, including mobile phones, PDAs, wireless headsets, notebook computers, related peripherals, and the like. Using Bluetooth 4.0, communications between mobile communication terminal devices can be effectively simplified, and communications between devices and Internet can also be successfully simplified, thus making data transmission faster and more efficient and broadening the way for wireless communications. Using a distributed network structure and fast frequency-hopping and short packet technologies, Bluetooth supports point-to-point and point-to-multipoint communications and operates in the global universal 2.4 GHz ISM (i.e., Industrial, Scientific, Medical) frequency band. In the case of using Bluetooth 4.0 to transmit data to/from a smart phone or other intelligent devices, a usual technical solution involves that a Bluetooth device broadcasts first, and then the smart phone discovers the Bluetooth device by scanning, followed by pairing and reading of the Bluetooth service to acquire data. In a conventional technical solution, if a link is maintained for a long time, a dropping rate of the Bluetooth device may be relatively high (perhaps because of such reasons as interference with signals, changes in distance, or the like). After dropping, the only way is to repeat connection, pairing and data acquisition; what's more, it may cause the loss of part or all of data with an awfully bad user experience. In addition, after a connection is established by means of a Bluetooth interface, only one-to-one or at most one-to-seven data transmission can be made between the Bluetooth device and the smart phone. In the case of requiring a Bluetooth device to transmit same data to more devices without delay, the Bluetooth device needs to connect to those devices and then transmit data thereto one by one with extremely low transmission efficiency.

### SUMMARY OF THE INVENTION

In view of the above problems of extremely low transmission efficiency and bad customer experience due to the need of connection and data transmission one by one, the present invention provides an intelligent sensor for sending sensing data in a disconnected state, at least including: a sensing module, used for detecting sensing data; a sensing data encapsulation module, used for encapsulating the sensing data into a valid payload data segment of a connectable non-directional Bluetooth broadcast data packet or a non-connectable non-directional Bluetooth broadcast data packet that conforms to the Bluetooth 4.0 protocol; and a Bluetooth sending module, used for outwardly broadcasting the connectable non-directional Bluetooth broadcast data packet or the non-connectable non-directional Bluetooth broadcast data packet. Preferably, the sensing data is temperature data or humidity data or exercise consumed caloric data.

The present invention also provides an intelligent device for acquiring sensor data in a disconnected state, including: a Bluetooth interface module, used for receiving a connectable non-directional Bluetooth broadcast data packet or a non-connectable non-directional Bluetooth broadcast data packet that conforms to the Bluetooth 4.0 protocol from an external sensor, wherein the connectable non-directional Bluetooth broadcast data packet or the non-connectable non-directional Bluetooth broadcast data packet includes a valid payload data segment; a sensing data parsing module, used for parsing the received connectable non-directional Bluetooth broadcast data packet or non-connectable non-directional Bluetooth broadcast data packet to obtain sensing data from the valid payload data segment; and a display module, used for displaying the sensing data.

Preferably, the intelligent device further includes a voice broadcast module used for voice broadcast of the sensing data.

Preferably, the sensing data is temperature data or humidity data or exercise consumed caloric data.

Preferably, the intelligent device is a smart phone or a tablet computer or a PDA.

In addition, the present invention also provides a method for acquiring sensor data in a disconnected state by using the Bluetooth 4.0 protocol, including the following steps: a sensor detecting sensing data, and encapsulating the sensing data into a valid payload data segment of a connectable non-directional Bluetooth broadcast data packet or a non-connectable non-directional data packet that conforms to the Bluetooth 4.0 protocol; the sensor broadcasting the connectable non-directional Bluetooth broadcast data packet or the non-connectable non-directional data packet that conforms to the Bluetooth 4.0 protocol; an intelligent device receiving the connectable non-directional Bluetooth broadcast data packet or the non-connectable non-directional data packet that conforms to the Bluetooth 4.0 protocol and parsing a valid payload data segment from the connectable non-directional data packet or the non-connectable non-directional data packet, thereby acquiring the sensing data. Preferably, the sensing data is temperature data or humidity data or exercise consumed caloric data.

With the technical solutions according to this invention, the present invention can enable an intelligent device to acquire the sensing data transmitted by a Bluetooth device in the broadcasting stage of the Bluetooth device without establishing a further data link, and can enable simultaneous high-efficiency data transmission from a single Bluetooth device to a plurality of intelligent devices; thus, the reading operations of an intelligent device reading intelligent peripheral data are simplified, and the user experience is greatly improved.

### BRIEF DESCRIPTION OF THE DRAWINGS

FIG. 1 is a general flow diagram of data transmission using Bluetooth in the prior art;

FIG. 2 is a schematic diagram of a Bluetooth broadcast data packet format of the Bluetooth 4.0 protocol in the prior art;

FIG. 3 is a structural schematic diagram of an intelligent sensor according to one embodiment of the present invention;

FIG. 4 is a schematic diagram of a format of a Bluetooth broadcast data packet according to one embodiment of the present invention;

FIG. 5 is a structural schematic diagram of a smart phone according to one embodiment of the present invention;

FIG. 6 is a flow diagram of a smart phone receiving disconnected sensing data according to one embodiment of the present invention;

FIG. 7 is a schematic diagram of a format of a Bluetooth broadcast data packet according to one embodiment of the present invention;

FIG. 8 is a schematic diagram of a format of a Bluetooth broadcast data packet according to one embodiment of the present invention;

FIG. 9 is a schematic diagram of a format of a Bluetooth broadcast data packet according to one embodiment of the present invention.

### DETAILED DESCRIPTION OF THE EMBODIMENTS

The present invention will be described in detail below in conjunction with specific embodiments, but is not limited to the enumerated embodiments.

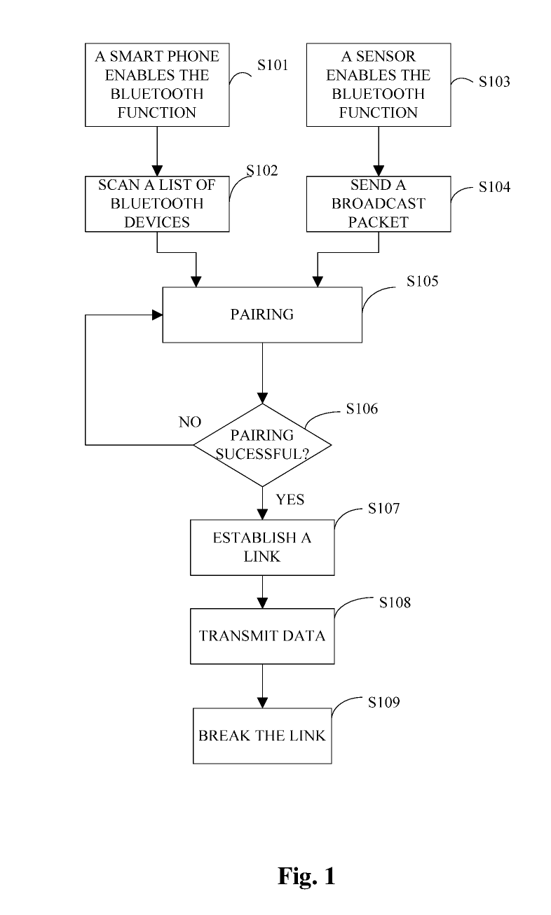

FIG. 1 is the general flow diagram of data transmission using the Bluetooth 4.0 protocol in the prior art. During data communication using the Bluetooth 4.0 protocol, first, a smart phone enables the Bluetooth function at S101, then operates at a Bluetooth master device, and initiates scanning search for Bluetooth slave devices within a certain distance range (e.g., 1-100 m) around in 2.4 GHZ frequency band at a certain transmitting power at S102. At this time, the Bluetooth slave devices are required to be in a findable state, i.e., also with the Bluetooth function enabled at S103, to outwardly send broadcast packets at S104. The smart phone selects a desired Bluetooth slave device from a list of Bluetooth slave devices obtained through scanning for pairing at S105. At that time, it is required to input a pairing password of the Bluetooth slave device on the smart phone; and after successful pairing at S106, the Bluetooth master device records the address of the Bluetooth slave device, and pairing is done. The Bluetooth slave device will records trust information of the Bluetooth master device; thereafter, either the Bluetooth master device or the slave device can initiate a request to establish a link at S107. After successful establishment of the link, unidirectional or bidirectional data transmission can be carried out between the master and slave terminals at S108. In a communication state, both the master device and slave devices can initiate link disconnection, or after the completion of data transmission, the link is automatically broken at S109. Bluetooth 4.0 protocol broadcasts of the following several types can be set:

1) connectable non-directional broadcast (ADV_IND);
2) connectable directional broadcast (ADV_DIR_IND);
3) scannable non-directional broadcast (ADV_SCAN_IND);
4) non-connectable non-directional broadcast (ADV_NON_CONN_IND);
5) scan response broadcast (ADV_SCA_RSP).

So-called “directional” and “non-directional” are described with respect to broadcast objects. Broadcasts (which can contain device addresses of target objects), if directed to specified objects, are directional, or otherwise, are non-directional. The terms “Connectable” and “non-connectable” mean whether a connection request is accepted. If a broadcast is of the non-connectable broadcast type, it will not respond to the connection request. The scannable type means responding to a scan request. Further modification and applications are made to the connectable non-directional broadcast data packet and the non-connectable non-directional broadcast data packets in the present invention.

The broadcast data packet format of the Bluetooth 4.0 protocol is shown in FIG. 2, wherein a synchronous code, a channel, an address, and ADV_PUD_TYPE are all standard components of the Bluetooth protocol. The synchronous code is a clock signal; the channel is a selected channel type; the address is the device address sending the broadcast; the ADV_PUD_TYPE indicates whether a selected broadcast packet is a connectable non-directional broadcast data packet or a non-connectable non-directional broadcast data packet; and these are followed by variable length payload and check.

Through extended definition made to broadcast data packets of the Bluetooth 4.0 protocol in the present invention, each broadcast data packet is enabled to carry certain valid payload data; by further defining and parsing the valid payload data, data broadcast transmission from a Bluetooth 4.0 protocol slave device to a Bluetooth master device may be done before pairing without further link establishment.

An intelligent device, an intelligent sensor, and a method of the present invention will be described below with specific embodiments.

### Embodiment 1

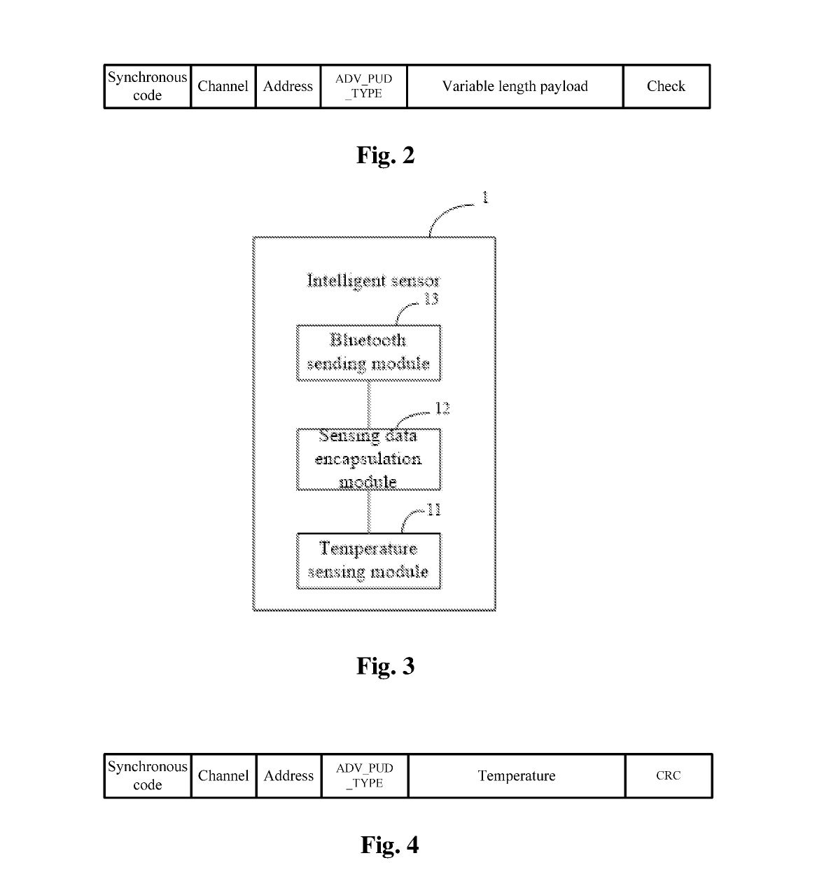

An intelligent sensor with a Bluetooth 4.0 interface and used for detecting ambient temperatures is arranged in an environment where smart phones, tablet computers and the like are used, for example, in a shopping mall or a meeting place. The smart phones, the tablet computers and the like may use Apple's operating system or Android system. Intelligent sensor 1 includes: at least one temperature sensing module 11, used for detecting ambient temperatures; a sensing data encapsulation module 12, used for encapsulating the ambient temperature data into a non-connectable non-directional Bluetooth broadcast data packet that conforms to the Bluetooth 4.0 protocol; and a Bluetooth sending module 13, used for sending and broadcasting the Bluetooth broadcast data packet containing the temperature sensing data around, with the structural schematic diagram thereof shown in FIG. 3.

The temperature sensing module carries out ambient temperature detection. After the temperature detection is done, the sensing data encapsulation module encapsulates the ambient temperature data, for example, 22° C., into a non-connectable non-directional Bluetooth broadcast data packet that conforms to the Bluetooth 4.0 protocol. A valid payload data segment is defined in the Bluetooth broadcast data packet to allow the temperature data detected by the sensing module to be embedded in the valid payload data segment. The format of the Bluetooth data packet of the broadcast is shown in FIG. 4, wherein a synchronous code, a channel, an address, and ADV_PUD_TYPE are all standard components of the Bluetooth protocol. The synchronous code is a clock signal; the channel is a selected channel type; the address is the device address sending the broadcast; the ADV_PUD_TYPE indicates the selected broadcast packet is a non-connectable non-directional broadcast data packet. The valid payload data is the temperature sensing data. A cyclic redundancy check (CRC) code is used for performing cyclic redundancy check on the transmitted data. Next, the Bluetooth sending module broadcasts and sends the encapsulated non-connectable non-directional Bluetooth broadcast data packet in the shopping mall or the meeting place. All the smart phones within the Bluetooth effective receiving range can receive the broadcast data by scanning.

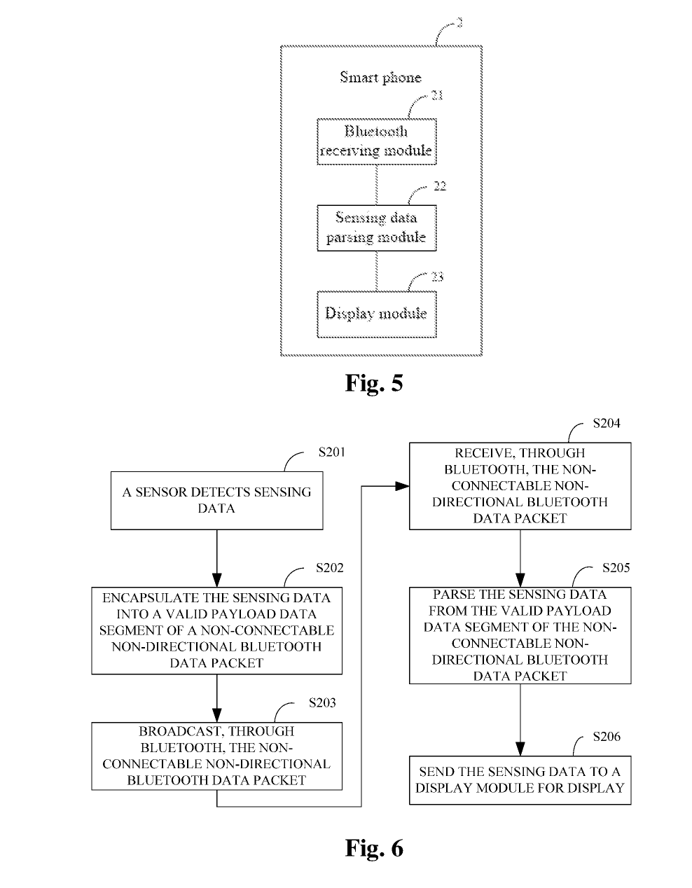

A smart phone used for receiving the broadcast sent by the intelligent sensor includes: a Bluetooth receiving module 21 for receiving a non-connectable non-directional Bluetooth broadcast data packet that conforms to Bluetooth 4.0 protocol from an external sensor, wherein the non-connectable non-directional Bluetooth broadcast data packet includes a valid payload data segment; a sensing data parsing module 22 for parsing the received non-connectable non-directional Bluetooth broadcast data packet to obtain the temperature sensing data from the valid payload data segment; and a display module 23 for displaying the sensing data. A structural schematic diagram of the smart phone is shown in FIG. 5. A flow diagram of the smart phone acquiring the sensing data of the intelligent sensor in a disconnected manner is shown in FIG. 6. First, the intelligent sensor detects sensing data at S201, and then encapsulates the sensing data into the valid payload segment of a non-connectable non-directional Bluetooth broadcast data packet at S202. Next, the Bluetooth module of the intelligent sensor cyclically broadcasts, through Bluetooth, the non-connectable non-directional Bluetooth broadcast data packet at S203. After the smart phone enables the Bluetooth, a Bluetooth interface module receives the non-connectable non-directional Bluetooth broadcast data packet broadcasted by the intelligent sensor in the environment (the meeting place or the shopping mall) at S204. Then the sensing data parsing module of the smart phone parses the valid payload data segment from the non-connectable non-directional data packet at S205, thereby acquiring the sensing data, and performs CRC on the received data with the received CRC data. Finally, the sensing data is sent to the display module for display at S206, for example, 22° C.

The smart phone may also include a voice broadcast module for voice broadcast of the temperature sensing data. For example, it may be set to broadcast in a format “the ambient temperature now is 22° C.”.

The sensing data encapsulation module may also be reconstructed to encapsulate the ambient temperature data into a connectable non-directional Bluetooth broadcast data packet that conforms to the Bluetooth 4.0 protocol, and the sensing data parsing module may be reconstructed to parse the received connectable non-directional Bluetooth broadcast data packet, and all the non-connectable non-directional broadcast data packets in this embodiment are replaced with the connectable non-directional broadcast data packets, while the method of acquiring the temperature sensing data does not need any change.

Through embodiment 1, the present invention can enable a smart phone to acquire the temperature sensing data transmitted by the intelligent sensor in the broadcasting stage of the intelligent sensor without establishing a further data link, and can enable simultaneous high-efficiency data transmission from a single intelligent sensor to a plurality of smart phones; thus, the reading operations of a smart phone reading the intelligent sensor data are simplified, and the user experience is greatly improved.

### Embodiment 2

Similarly, an intelligent sensor with a Bluetooth interface and used for detecting ambient humidity is arranged in an environment where smart phones, tablet computers and the like are used, for example, in a shopping mall or a meeting place. The intelligent sensor includes: at least one humidity sensing module, used for detecting ambient humidity; a sensing data encapsulation module, used for encapsulating the ambient humidity data into a non-connectable non-directional Bluetooth broadcast data packet that conforms to the Bluetooth 4.0 protocol; and a Bluetooth sending module, used for sending and broadcasting the Bluetooth broadcast data packet containing the humidity sensing data around.

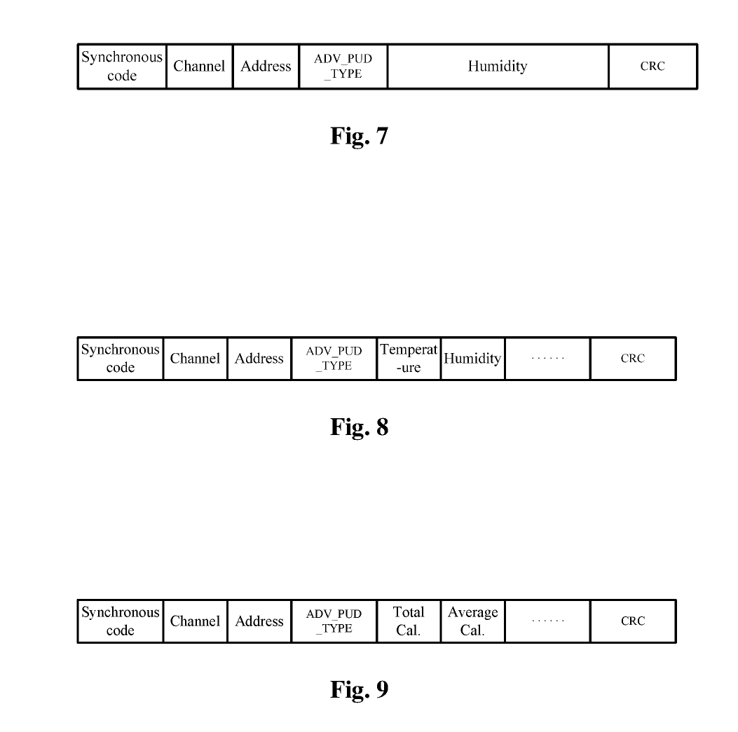

After the humidity sensing module finishes humidity detection, the sensing data encapsulation module embeds the obtained humidity sensing data into a non-connectable non-directional Bluetooth broadcast data packet. Specifically, the humidity data is embedded into the valid payload data segment of the non-connectable non-directional Bluetooth broadcast data packet. The format of such a non-connectable non-directional Bluetooth broadcast data packet is shown in FIG. 7. The same definitions as above are made to the synchronous code, the channel, the address, and the ADV_PUD_TYPE. The valid payload data is the humidity sensing data. Then, the Bluetooth sending module broadcasts and sends the encapsulated non-connectable non-directional Bluetooth broadcast data packet in the shopping mall or the meeting place. All the smart phones the same as those in embodiment 1 within the Bluetooth effective receiving range can receive the broadcast data by scanning, and disassemble the valid payload data from the data packet, as well as perform CRC on the received data with the received CRC data. For example, the humidity is 70%. In this way, all the smart phones entering the environment can receive the broadcast message.

Similar to embodiment 1, the sensing data encapsulation module may also be reconstructed to encapsulate the ambient humidity data into a connectable non-directional Bluetooth broadcast data packet that conforms to the Bluetooth 4.0 protocol, and the sensing data parsing module may be reconstructed to parse the received connectable non-directional Bluetooth broadcast data packet, and all the non-connectable non-directional broadcast data packets in this embodiment are replaced with the connectable non-directional broadcast data packets, while the method of acquiring the humidity sensing data does not need any change.

Through embodiment 2, the present invention can enable a smart phone to acquire the ambient sensing data transmitted by the intelligent sensor in the broadcasting stage of the intelligent sensor without establishing a further data link, and can enable simultaneous high-efficiency data transmission from a single intelligent sensor to a plurality of smart phones; thus, the reading operations of a smart phone reading the intelligent sensor data are simplified, and the user experience is greatly improved.

### Embodiment 3

Similarly, a multi-information fusion sensor with a Bluetooth interface and capable of detecting various types of sensing information, including ambient temperatures and humidity is arranged in an environment where smart phones, tablet computers and the like are used, for example, in a shopping mall or a meeting place. The intelligent sensor includes: at least one humidity sensing module, used for detecting ambient humidity; at least one temperature sensing module, used for detecting ambient temperatures; a sensing data encapsulation module, used for encapsulating the ambient humidity data and humidity sensing data into a non-connectable non-directional Bluetooth broadcast data packet that conforms to the Bluetooth 4.0 protocol; and a Bluetooth sending module, used for sending and broadcasting the Bluetooth broadcast data packet containing the humidity sensing data around.

After the humidity sensing module finishes humidity detection, the sensing data encapsulation module embeds the obtained temperature sensing data and humidity sensing data into a non-connectable non-directional Bluetooth broadcast data packet. Specifically, the humidity data is embedded into a different data portion of the valid payload data segment of the non-connectable non-directional Bluetooth broadcast data packet. The format of such a data packet is shown in FIG. 8. The temperature is put before the humidity; certainly, it may also be possible to put the humidity before the temperature. Then, the Bluetooth sending module broadcasts and sends the encapsulated non-connectable non-directional Bluetooth broadcast data packet in the shopping mall or the meeting place. Same definitions as above are made to the synchronous code, the channel, the address, and the ADV_PUD_TYPE. All the smart phones the same as those in embodiment 1 within the Bluetooth effective receiving range can receive the broadcast data by scanning, and disassemble the valid payload data from the data packet, as well as perform CRC on the received data with the received CRC data. For example, the temperature is 22° C., and the humidity is 70%. In this way, all the smart phones entering the environment can receive the broadcast message.

Similar to embodiment 1, the sensing data encapsulation module may also be reconstructed to encapsulate the ambient temperature and humidity data into a connectable non-directional Bluetooth broadcast data packet that conforms to the Bluetooth 4.0 protocol, and the sensing data parsing module may be reconstructed to parse the received connectable non-directional Bluetooth broadcast data packet, and all the non-connectable non-directional broadcast data packets in this embodiment are replaced with the connectable non-directional broadcast data packets, while the method of acquiring the temperature, humidity sensing data does not need any change.

Through embodiment 3, the present invention can enable a smart phone to acquire the temperature and humidity sensing data transmitted by the multi-information fusion intelligent sensor in the broadcasting stage of the intelligent sensor without establishing a further data link, and can enable simultaneous high-efficiency transmission of various sensing data from an intelligent sensor to a plurality of smart phones; thus, the reading operations of a smart phone reading the intelligent sensor data are simplified, and the user experience is greatly improved.

### Embodiment 4

Similarly, the intelligent sensor may also be an intelligent caloric consumption computing device with a Bluetooth 4.0 interface and used for detecting exercise consumed calories. It may be arranged in an environment where smart phones, tablet computers and the like are used, for example, in a fitness room or a gym. A Bluetooth device for detecting the exercise consumed calories calculates total caloric consumption and average caloric consumption after a piece of physical exercise is done, embeds the obtained caloric data into a non-connectable non-directional Bluetooth broadcast data packet and broadcasts it in the environment. The format of the non-connectable non-directional Bluetooth broadcast data packet is shown in FIG. 9. All the smart phones within the Bluetooth effective receiving range can receive the broadcast data by scanning, and disassemble valid payload data from the data packet, as well as perform CRC on the received data with the received CRC data. For example, the average caloric consumption is 350 calories per hour, and the total consumption is 700 calories. In this way, the smart phones of all the exercisers entering the environment can receive the broadcast message.

Similar to embodiment 1, the sensing data encapsulation module may also be reconstructed to encapsulate the exercise consumed caloric data into a connectable non-directional Bluetooth broadcast data packet that conforms to the Bluetooth 4.0 protocol, and the sensing data parsing module may be reconstructed to parse the received connectable non-directional Bluetooth broadcast data packet, and all the non-connectable non-directional broadcast data packets in this embodiment are replaced with the connectable non-directional broadcast data packets, while the method of acquiring the exercise consumed caloric data does not need any change. Through embodiment 4, the present invention can enable a smart phone to acquire various exercise consumed caloric data transmitted by the intelligent sensor in the broadcasting stage of the intelligent sensor without establishing a further data link, and can enable simultaneous high-efficiency data transmission from a single intelligent sensor to a plurality of smart phones; thus, the reading operations of a smart phone reading the intelligent sensor data are simplified, and the user experience is greatly improved.

### Embodiment 5

Similarly, a Bluetooth device with a Bluetooth 4.0 interface and capable of editing text short messages may be arranged in an environment where smart phones, tablet computers and the like are used, for example, in a shopping mall, an exclusive shop or a plaza. A sender embeds a multimedia short message to be pushed into a non-connectable non-directional broadcast data packet by means of the Bluetooth device and broadcasts the data packet in the environment. The format of the non-connectable non-directional broadcast data packet is the same as that described in Embodiment 2. All the smart phones within the Bluetooth effective receiving range can receive the broadcast data by scanning, and disassemble valid payload data from the data packet, as well as perform CRC on the received data with the received CRC data. For example, the received data may be the commodity promotion information, public welfare propaganda, and safety indicator lights. In this way, the smart phones of all the exercisers entering the environment can receive the broadcast message. Through embodiment 5, the present invention can enable a smart phone to acquire the text short message data transmitted by a Bluetooth device in the broadcasting stage of the Bluetooth device without establishing a further data link, and can enable simultaneous high-efficiency data transmission from a single Bluetooth device to a plurality of smart phones; thus, the reading operations of a smart phone reading the Bluetooth device data are simplified, and the user experience is greatly improved. The present invention is not limited to the above-mentioned Bluetooth 4.0 protocol, and for other similar Bluetooth protocols or wireless data transmission protocols, the above ideas presented in the present invention may also be utilized to achieve the purpose of broadcasting sensing data or short messages in a disconnected manner. The types of the transmitted data are also not limited to the sensing data, and the broadcast data may be a fusion of various information, and text, audio and video short messages, and the like.

1. An intelligent sensor for sending sensing data in a disconnected state, comprising:
a sensing module, used for detecting sensing data;
a sensing data encapsulation module, used for encapsulating the sensing data into a valid payload data segment of a connectable non-directional Bluetooth broadcast data packet or a non-connectable non-directional Bluetooth broadcast data packet that conforms to Bluetooth 4.0 protocol; and
a Bluetooth sending module, used for outwardly broadcasting the connectable non-directional Bluetooth broadcast data packet or the non-connectable non-directional Bluetooth broadcast data packet.

2. The intelligent sensor according to claim 1, characterized in that the sensing data at least comprises temperature data or humidity data or exercise consumed caloric data.

3. An intelligent device for acquiring sensor data in a disconnected state, comprising:
a Bluetooth interface module, used for receiving a connectable non-directional Bluetooth broadcast data packet or a non-connectable non-directional Bluetooth broadcast data packet that conforms to Bluetooth 4.0 protocol from an external sensor, wherein the connectable non-directional Bluetooth broadcast data packet or the non-connectable non-directional Bluetooth broadcast data packet comprises a valid payload data segment;
a sensing data parsing module, used for parsing the received connectable non-directional Bluetooth broadcast data packet or non-connectable non-directional Bluetooth broadcast data packet to obtain sensing data from the valid payload data segment; and a display module, used for displaying the sensing data.

4. The intelligent device according to claim 3, further comprising a voice broadcast module used for voice broadcast of the sensing data.

5. The intelligent device according to claim 3, characterized in that the sensing data at least comprises temperature data or humidity data or exercise consumed caloric data.

6. The intelligent device according to claim 3, characterized in that the intelligent device a smart phone or a tablet computer or a PDA.

7. A method for acquiring sensor data in a disconnected state by using Bluetooth 4.0 protocol, comprising the following steps:
a sensor detecting sensing data, and encapsulating the sensing data into a valid payload data segment of a connectable non-directional data packet or a non-connectable non-directional data packet that conforms to the Bluetooth 4.0 protocol;
the sensor broadcasting the connectable non-directional data packet or the non-connectable non-directional data packet that conforms to the Bluetooth 4.0 protocol;
an intelligent device receiving the connectable non-directional data packet or the non-connectable non-directional data packet that conforms to the Bluetooth 4.0 protocol and parsing a valid payload data segment from the connectable non-directional data packet or the non-connectable non-directional data packet, thereby acquiring the sensing data.

8. The method according to claim 7, characterized in that the sensing data is temperature data or humidity data or exercise consumed caloric data.
